(19) United States
(12) Patent Application Publication
(10) Pub. No.: US 2020/0068873 A1
(43) Pub. Date: Mar. 5, 2020

(54) Decoy Control Apparatus

(71) Applicants: Timothy Rhodes, New Bern, NC (US); Kyle Taylor, Swansboro, NC (US); Wesley Redfearn, Swansboro, NC (US)

(72) Inventors: Timothy Rhodes, New Bern, NC (US); Kyle Taylor, Swansboro, NC (US); Wesley Redfearn, Swansboro, NC (US)

(21) Appl. No.: 16/119,001

(22) Filed: Aug. 31, 2018

(51) Int. Cl. A01M 31/06; B63B 21/50; B63B 21/24

(52) U.S. Cl. CPC A01M 31/06; B63B 21/243; B63B 21/50

(57) ABSTRACT

A decoy control apparatus for organizing and displaying a spread of buoyant decoys in a free-surface marine environment, the decoy control apparatus including a pliant, water permeable sheet for subsurface deployment with a plurality of buoyant decoys attached thereto for surface display of the plurality of buoyant decoys grouped in a predetermined spread, a tethering assembly mounted to the sheet for removable attachment of a plurality of buoyant decoys thereto and a ballast attachment arrangement fixed to at least one end edge of the sheet for attachment of at least one ballast weight thereto to downwardly bias the sheet against the upward bias of the buoyant decoys, thereby stabilizing the sheet in a subsurface disposition intermediate the surface-borne buoyant decoys and the at least one ballast weight.

### BACKGROUND OF THE INVENTION

The present invention relates broadly to hunting aides, such as lures and the like, and, more particularly, to an apparatus for controlling decoys on the surface of a body of water to display the decoys in a realistic spread to attract airborne ducks.

Hunters, particularly duck hunters, often employ decoys when trying to lure game. Buoyant decoys are a strategic part of duck hunting, which can be practiced in a marine environment such as marshes or wetlands that include a free-surface body of water. Hunters will often deploy multiple decoys across a predetermined portion of the water surface to define a decoy spread.

Predetermined decoy spreads are deployed in a manner to define a landing zone for airborne ducks. Airborne ducks land upwind and will not overfly the head of another duck. Accordingly, a landing zone is typically defined by multiple decoys deployed in spreads and are often accompanied by single decoys and decoys of various species to provide a realistic landing zone that will tend to attract airborne ducks. Generally, the more realistic the appearance of the defined landing zone, the more likely airborne ducks will find it attractive enough to land.

Multiple decoys may be deployed individually with weighted lines attached to each individual decoy, which are then set out in the water in a predefined pattern to form a spread. Due to the time and expense involved with such multiple individual deployments, it became desirable to deploy multiple decoys in organized groups.

In the past, people with access to fishing nets have deployed multiple decoys tied to such fishing nets to keep the decoys in a loose pattern. With multiple, buoyant decoys deployed on the water surface, the net is weighted and forced to sink below the surface. Such a device may be difficult to operate and maintain. A net constructed for fishing and pressed into such service can tend to be overly pliant for the task at hand when it comes to organizing and displaying decoys. The decoys are free to move about within certain confines yet often the result is unnatural movement with decoys milling awkwardly about and bumping into one another, and therefore may not present a sufficiently realistic appearance to attract the desired airborne ducks. In addition, post-hunting decoy gathering and storage of the apparatus can also be problematic due to its haphazard construction and tendency to retain water.

It is therefore desirable to provide a decoy control apparatus that addresses and solves the foregoing deficiencies in the art.

### SUMMARY OF THE INVENTION

It is therefore an object of the present invention to provide an apparatus for defining, organizing, displaying and controlling a predetermined spread of decoys which will maintain the spread over time while in use.

It is also the object of the present invention to provide such a decoy control apparatus that will provide structure capable of a rapid and simple take-down for post-hunting transportation and storage.

To those collective ends, and according to one preferred embodiment thereof, the present invention is directed to a decoy control apparatus for defining, organizing and displaying a spread of buoyant decoys in a free-surface marine environment. The decoy control apparatus includes a pliant, water permeable sheet for subsurface deployment, with the sheet having two side edges and two end edges. The sheet is deployable with a plurality of buoyant decoys attached thereto for surface display of the plurality of buoyant decoys grouped in a predetermined spread.

When in use, the sheet is maintained in a submersed, operational condition by a tethering assembly in conjunction with an ballast attachment arrangement. The tethering assembly attaches the decoys to the sheet and maintains the decoys in relative position within the spread. The ballast attachment arrangement facilitates use of a ballast weight to maintain the sheet in a submersed condition and to discourage the decoy spread from drifting. Both the tethering assembly and the ballast attachment arrangement contribute to maintaining a realistic decoy spread and thereby contribute to the effectiveness of the present decoy control apparatus.

The tethering assembly is mounted to the sheet for removable, individual attachment of a plurality of buoyant decoys thereto. The tethering assembly includes a plurality of anchor arrangements, with each anchor arrangement including a first link formed from a rigid material, a second link formed from a flexible material, and a mounting arrangement for connecting the second link to the sheet. The first link is directly and movably attached to the second link, thereby restricting movement of the first link relative to the second link. The first link is removably attachable to a buoyant decoy. Preferably, the anchor arrangements are attached to the sheet in a predetermined pattern to thereby define a decoy spread.

The ballast attachment arrangement is fixed to at least one end edge of the sheet for attachment of at least one ballast weight thereto to downwardly bias the sheet against the upward bias of the buoyant decoys. This stabilizes the sheet in a subsurface disposition intermediate the surface-borne buoyant decoys and the at least one ballast weight, thereby displaying the predetermined spread of buoyant decoys on the free-surface marine environment.

Preferably, the water permeable sheet includes at least a portion thereof formed from mesh material wherein openings in the mesh material can pass water therethrough, thereby facilitating submersability of the decoy control apparatus. It is further preferred that the mesh material is formed from a polymer material.

Preferentially, each anchor arrangement includes a first link formed as a manually openable clip for selective operative engagement with the second link and a buoyant decoy. Each anchor arrangement further preferably includes a second link formed as an elongate member folded to define a loop at a distal end thereof, with the loop being configured for selective operative engagement with the first link and wherein a proximal end of the second link is joined to the mounting arrangement. A clamping element may preferably be fitted to the second link adjacent the distal end of the folded elongate member to limit an open area defined by the clamping element and the elongate member for passage of the first link therethrough, thereby limiting movement of the first link relative to the second link.

It is preferred that each anchor arrangement include a backing member attached to the sheet, and a cover member attached to the backing member, thereby defining a space intermediate the cover member and the backing member. The cover member preferably has an access aperture formed therein for passage of a proximal end of the second link therethrough, and a retainer element attached to the cover member on a side of the cover member facing the backing member, for retention of the proximal end of the second link in the space intermediate the cover member and the backing member. Preferably, the retainer element is a washer-like structure having a central aperture and the second link includes two legs, with each leg having a flared end, Preferentially, both legs of the second link can pass simultaneously though the central aperture, wherein both flared ends cannot pass simultaneously though the central aperture, thereby retaining the second link with both flared ends disposed in the space intermediate the cover member and the backing member. The second link may be formed from a bendable, polymer-coated metal wire.

Preferably, the ballast mounting arrangement includes a traverse rod operatively associated with the sheet and configured for attachment of a ballast weight thereto for biasing the sheet into a stationary, sub-surface disposition during use. The ballast attachment arrangement preferably includes at least one rod retaining sleeve attached to at least one end of the sheet. The rod retaining sleeve may be formed as a planar element having an opening formed therein. The planar element may be pliant and folded along a long axis thereof to define two planar sides, with each planar side being attached to opposing surfaces of the sheet thereby defining traversely-extending cavity therebetween for rod receipt. Preferably, the opening in the planar element exposes a section of the rod in the cavity for selective engagement by the ballast weight. Further, the rod may be formed in sections and is configured for partial disassembly, such that the rod can be folded for stowage with a folded sheet.

According to another preferred embodiment thereof, the present invention is directed to a decoy control apparatus for organizing and displaying a spread of buoyant decoys in a free-surface marine environment. The decoy control apparatus includes a pliant, water permeable sheet for subsurface deployment, the sheet having two side edges and two end edges. The sheet is deployable with a plurality of buoyant decoys attached thereto for surface display of the plurality of buoyant decoys grouped in a predetermined spread.

Further, a tethering assembly is mounted to the sheet for removable, individual attachment of a plurality of buoyant decoys thereto. The tethering assembly includes a plurality of anchor arrangements, with each anchor arrangement including a first link, a second link and a mounting arrangement for mounting the second link to the sheet. The first link is directly and movably attached to the second link, thereby restricting movement of the first link relative to the second link. The first link is removably attachable to a buoyant decoy.

In addition, a ballast attachment arrangement is provided and includes a rod operatively associated with the sheet and a rod retaining sleeve fixed to at least one end edge of the sheet for rod receipt. The sleeve is configured for rod access to allow attachment of at least one ballast weight thereto to downwardly bias the sheet against the upward bias of the buoyant decoys, thereby stabilizing the sheet in a subsurface disposition intermediate the surface-borne buoyant decoys and the at least one ballast weight, and thereby displaying the predetermined spread of buoyant decoys on the free-surface marine environment.

Preferably, the rod retaining sleeve is formed as a planar element having an opening formed therein for rod access. The planar element is pliant and folded along a long axis thereof to define two planar sides, with each planar side being attached to opposing surfaces of the sheet thereby defining a cavity therebetween for rod receipt. Preferentially, the opening in the planar element exposes a section of the rod in the cavity for selective engagement by the ballast weight.

Preferably, the water permeable sheet includes a portion formed from mesh material wherein openings in the mesh material can pass water therethrough, thereby facilitating submersability of the decoy control apparatus.

According to another preferred embodiment of the present invention, a decoy control apparatus for organizing and displaying a spread of buoyant decoys in a free-surface marine environment, the control apparatus includes a pliant, water permeable sheet for subsurface deployment, with the sheet having two side edges and two end edges. The sheet is deployable with a plurality of buoyant decoys attached thereto for surface display of the plurality of buoyant decoys grouped in a predetermined spread.

The present invention further includes a tethering assembly mounted to the sheet for removable, individual attachment of a plurality of buoyant decoys thereto. The tethering assembly includes a plurality of anchor arrangements, with each anchor arrangement including a first link formed from a rigid material, a second link formed from a flexible material, and a mounting arrangement for mounting the second link to the sheet. The first link is directly and movably attached to the second link, thereby restricting movement of the first link relative to the second link. The first link is removably attachable to a buoyant decoy.

A ballast attachment arrangement is provided and includes a rod operatively associated with the sheet and a rod retaining sleeve fixed to each end edge of the sheet for rod receipt. The sleeve includes an opening for rod access to allow attachment of at least one ballast weight thereto to downwardly bias the sheet against the upward bias of the buoyant decoys, thereby stabilizing the sheet in a subsurface disposition intermediate the surface-borne buoyant decoys and the at least one ballast weight, thereby displaying the predetermined spread of buoyant decoys on the free-surface marine environment.

By the above the present invention provides an effective decoy control apparatus for displaying a predetermined spread of decoys floating on a water surface which resists decoy bunching and resists drifting. Further, the present invention provides such a decoy control apparatus that is stowable in a straightforward manner.

### BRIEF DESCRIPTION OF THE DRAWINGS

FIG. 1 is a perspective view of a decoy control apparatus according to a preferred embodiment of the present invention;

FIG. 2 is a partial side view of the decoy control apparatus illustrated in FIG. 1;

FIG. 3 is a plan view of a rod sleeve under construction in accordance with the present invention;

FIG. 4 is a perspective view of an anchor arrangement in accordance with the present invention;

FIG. 5 is a side view of the anchor arrangement illustrated in FIG. 4;

FIG. 6 is a side view of a traverse rod shown in a breakdown condition; and

FIG. 7 is a perspective view of a decoy control apparatus in a stowage condition according to the present invention.

### DESCRIPTION OF THE PREFERRED EMBODIMENT

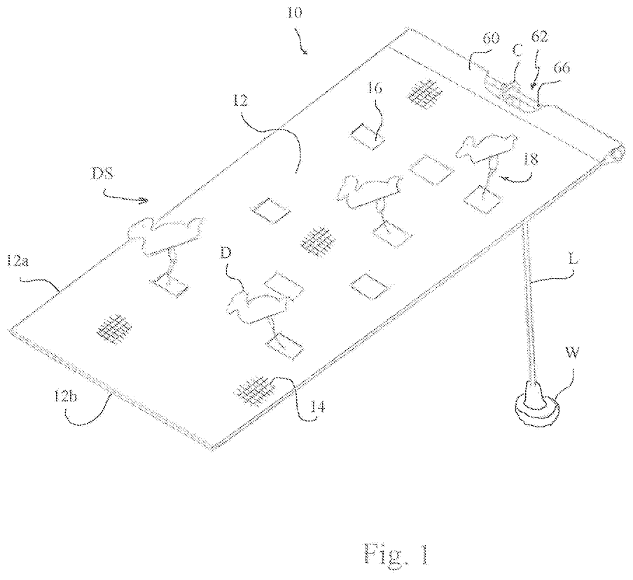

Turning now to the drawings and, more particularly to FIG. 1, a decoy control apparatus for organizing and displaying a spread of buoyant decoys D in a free-surface marine environment is illustrated generally at 10 and includes a pliant, water permeable sheet 12. The sheet 12 is generally planar and rectangular, and includes two side edges 12a and two end edges 12b. Designed for subsurface deployment, the sheet is formed from a mesh material that will allow water to pass through sufficiently to sink the sheet under the influence of a downward bias. It should be noted that in FIG. 1, the mesh 14 illustrated is indicative of the appearance of the entire sheet and it is only shown partially for clarity.

Realism is key to an effective decoy spread that will airborne ducks. The sheet 12 is sufficiently pliant so that it can bend under the influence of individual bobbing buoyant decoys D attached to the sheet 12 without causing or allowing unnatural movement, such as dragging any decoys at least partially under the surface. Such unnatural bobbing action can preclude a realistic display. On the other hand, the sheet is stiff enough to resist bunching if surface conditions such as wind and water movement urge the decoys D on the surface toward one another. Therefore, the realistic appearance of the spread may be maintained.

The sheet is formed from a polymer material having sufficient pliancy such that filaments may be woven into a mesh sheet that will provide the above-discussed shape retention properties.

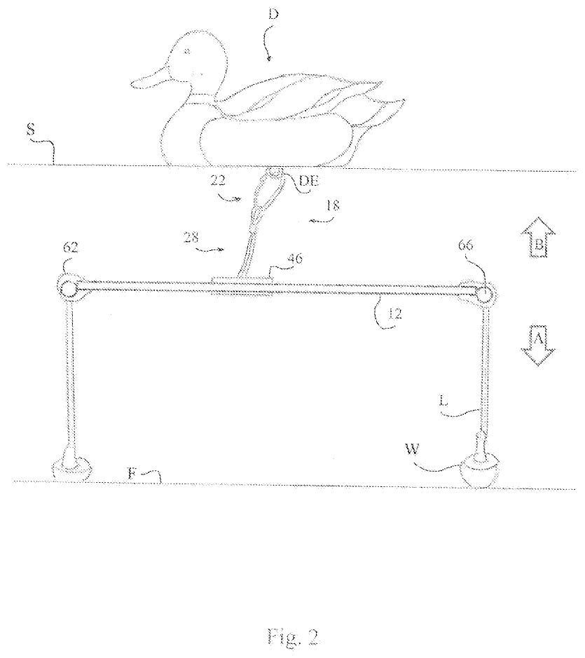

As will be discussed in greater detail hereinafter, and with reference to FIGS. 1 and 2, in use, the sheet 12 is maintained submersed at a predetermined depth by the combined action of the buoyant force on the decoys D floating on the surface of the water S and the ballast weight BW on the floor F of the marine environment. Therefore, the upward force provided by the buoyancy of the decoys, illustrated by arrow B, is offset by the downward force exerted by the ballast weight, indicated by arrow B, via line L.

With continued reference to FIGS. 1 and 2, a plurality of decoys D are tethered to individual anchor arrangements 16 using a tethering assembly 18. The anchor arrangements 16 are stitched, stapled or otherwise fixed to the mesh sheet 12 at locations which define the general location of each decoy D on the surface, thereby defining the decoy spread DS. The anchor arrangements 16 may be aligned or may be randomly positioned throughout the sheet to define the decoy spread DS. Since it is known to define multiple decoy spreads at any hunting location, hunters can obtain different predetermined spread patterns by using different sheets, all in accordance with to the present invention.

As stated above, realism is key to a successful decoy spread. Another important factor is the ability of the decoy spread to maintain a defined landing zone. Often, spreads of decoys will be laid out on either side of a predefined landing zone. No matter how realistic a decoy spread appears at first deployment, the effect can be ruined if the entire spread drifts into the landing zone thereby cutting off any inbound duck access. The present invention addresses both of these concerns by providing a realistic decoy spread pattern and resistance to drift.

A tethering assembly 18 is provided for attaching decoys to the sheet. With reference to FIG. 2, the tethering assembly 20 includes individual anchor arrangements to “anchor” a decoy D to the sheet 12. Each anchor assembly 20 includes a first link 22 attached to a second link 28 which is, in turn, attached to a base assembly 46. The base assembly 46 is attached to the sheet 12. The first link 22 is attached to the decoy D using an eyelet DE or other open device for receipt of the first link 22 therethrough.

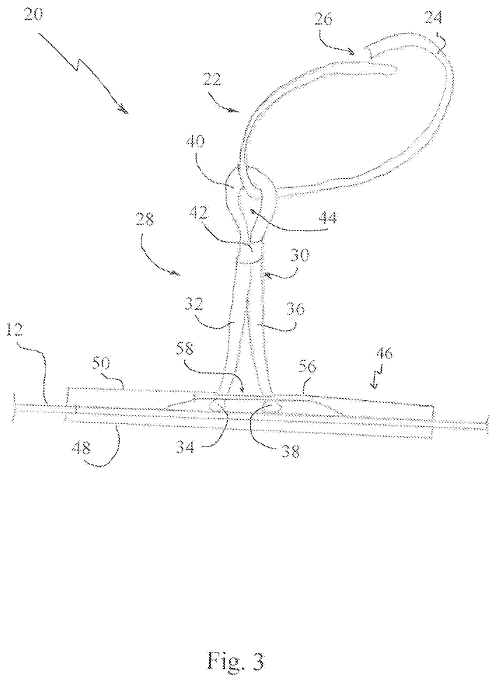

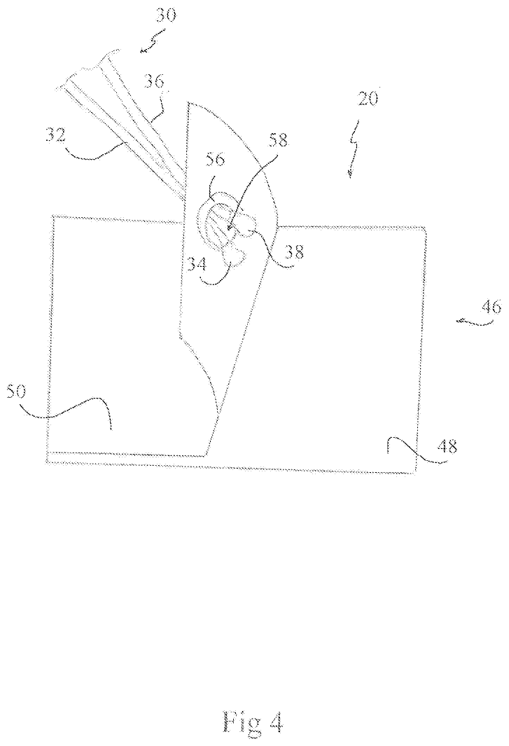

With reference to FIGS. 3 and 4, the tethering assembly 18 is illustrated with part of the base assembly 46 shown broken open to illustrate structure within. As seen in FIG. 3, the first link 22 is formed from bendable metal in the form of a ring or oval which includes two separate end portions for interconnection. One end portion is configured to receive the other end portion in abutment thereto for selective operability to open and close the first link 22. One open end portion is configured to receive the other end portion to form a latch 26 in a manner similar to the operation a of a safety pin. In this way, the clip 24 that forms the first link 22 may be selectively opened to engage the eyelet DS on a decoy for attaching the decoy to the tethering assembly 18 as best seen in FIG. 2.

With reference now to FIG. 3, the second link 28 is formed from a generally elongate member 30 that can be a wire coated with rubber or some polymer. The elongate member 30 is folded in half to define a first leg 32 and a second leg 36. The distal end of the second link 28 includes a curved end 40 where the elongate member 30 folds back on itself to define the legs 32, 36. A clamp 42 is placed around both legs 32, 26 to define a space 44 intermediate the curved end 40 and the clamp 42 through which the clip 24 is passed to make the first link 22 and the second link 28 movable relative to one another in a dependant manner, wherein movement of one link affects the other link.

The foregoing arrangement thereby precludes substantial individual movement of either the first link 22 or the second link 28. The result is a more natural movement of decoys D on the surface S. If wind or roiling water move the decoy, movement is limited to a few centimeters in either direction and complete rotation is prevented. Rotation is limited by the inability of the first link 22 to cross over the second link 28. With the first link 22 moving with the decoy D, rotation is restricted by the first link 22 abutting a non-rotating second link 28.

The second link 28 is mounted to the base assembly 46 in a manner that allows limited relative movement between the second link 28 and the base assembly 46. As seen in FIGS. 3 and 4, the base assembly 46 includes a backing member 48 attached to a cover 50. Both the backing member 48 and the cover 50 are formed from a semi-pliant polymer. An opening is formed in the cover 50 with a washer-like metallic retaining element 56 mounted to the cover 50 in registry with the cover opening to define an access opening 58 through which the legs 32, 36 may be individually inserted. The access opening is too small for both legs to fit through simultaneously. Each leg, 32, 36 is formed with a flared end 34, 38 respectively, and only one flared end 34, 38 may be passed through the access opening 58 in the retainer 56 at a time. Once both flared ends 34, 38 have been passed through the retainer opening 58 during manufacture, the cover 50 is stitched to the backing member 48 with the mesh sheet 12 intermediate the cover 50 and the backing member 48 for added strength, as illustrated in FIG. 3.

The foregoing tether assembly 18 is formed from multiple anchor arrangements 20 that are dispersed about the sheet 12 in a predetermined pattern to define the decoy spread DS. The anchor arrangements 20 are sufficiently stiff so as to distribute pulling force caused by the tension between the buoyant decoys and the ballast weight over a larger portion of the sheet than the contact surface between the second link 28 and the mesh sheet 12. Therefore, decoys D moving in the water will cause the sheet 12 to undulate rather than having individual decoys D pop free of their respective mounts.

The tethering arrangement through its use of two interconnected links that are not independently movable, in combination with the anchor arrangements fixing the second links to the mesh sheet in a predetermined distribution pattern across the mesh sheet, acts to provide a decoy spread that appears realistic in both a static situation and when decoys D are moving under influence of water movement, wind or both.

Stabilization of the decoy spread is maintained by a ballast weight as seen in FIG. 1 and FIG. 2. The structure of the present invention provides a convenient and effective ballast attachment arrangement for whatever ballast weight a user decides to employ. Such an ballast weight may be a boat anchor or other weighted element which may be homemade, such as a sand-filled plastic soda or pop bottle, or even a piece of junk metal. Whatever ballast weight a user chooses is attached to a line L which is, in turn, attached to an attachment device which may be a carabiner C.

With reference to FIGS. 1 and 2, the ballast attachment arrangement includes a cross-rod 66 and a rod sleeve 60 attached to an end edge 12b of the sheet 12 according to the present invention. As will be seen in greater detail hereinafter, an access opening 62 is provided for the carabiner C to engage the traverse rod 66 for ballast attachment. The ballast attachment arrangement includes a rod sleeve 60 attached to one end edge 12b of the sheet 12 as seen in FIG. 1, or two ballast attachment assemblies including two rod sleeves 60 that are attached to both end edges 12b of the sheet 12, depending on the needs of the user. FIG. 1 illustrates a single rod sleeve as the minimum necessary for successfully discouraging drift of the decoy spread.

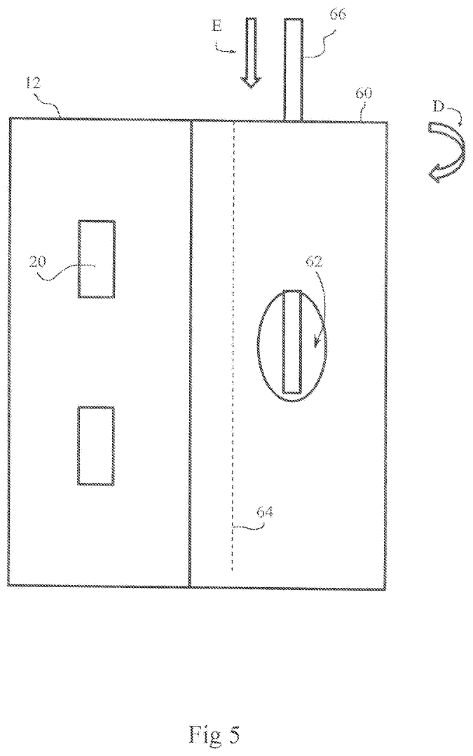

As seen in FIG. 5, the rod sleeve 60 is formed from a generally rectangular semi-pliant sheet 60 that may be formed from a polymer. The sheet forming the rod sleeve 60 includes a generally oval opening 62 for rod access during use. FIG. 5 illustrates partial assembly where one end of the rod sleeve 60 is stitched to the mesh sheet along a stitch line 64. Once this is accomplished, the rod sleeve 60 is curved back as shown by arrow D and the other end is stitched to the mesh sheet 12 in the like manner, thereby defining a space therebetween through which the rod 66 may be passed as indicated by arrow E. Accordingly, the rod 66 in the rod sleeve 60 passes by the access opening 62 and is held in place within the sleeve for access through the access opening 62 by a carabiner C to add ballast to the sheet 12. The rod 66 in the access opening 62 can conveniently be gripped by a user when maneuvering the sheet 12 into position or retrieving the sheet 12 from it marine environment.

In addition, although not illustrated, those skilled in the art will appreciate that multiple openings may be provided along the rod sleeve, particularly near each end, for multiple rod access points for attachment of extra ballast weights for large sheets that need such extra ballast.

By the foregoing, the present invention provides convenient access for attaching a ballast to the decoy control apparatus of the present invention to discourage drifting under the influence of water movements, wind or both.

When hunting is complete the present invention facilitates easy cleaning and stowage. The polymer coated mesh 12 sheet may be hosed off for cleaning and the pliability of the mesh sheet 12 makes it a straightforward operation to fold the sheet into the ever smaller sections once the decoys D are unmounted from the sheet 12. Any traverse rods 66 may be removed from their respective sleeves to allow the sheet 12 to be folded. The traverse rods 66 themselves may also be configured for folding.

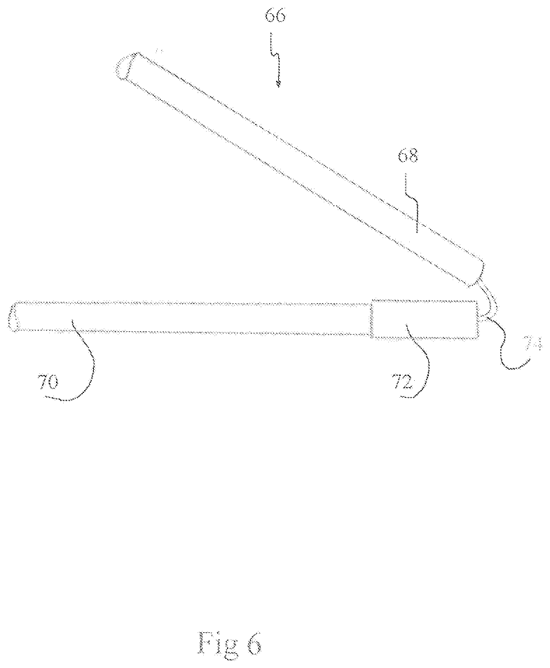

The traverse rod 66 may be formed in a number of sections that are configured for partial disassembly into smaller sections that remain attached to one another. With reference to FIG. 6, a first rod section 68 is joined to a second rod section 70 by an elastic strand 74. The second rod section 70 includes a sleeve 72 mounted thereto for receipt of a portion of the first rod section 68 which is drawn thereinto by action of the elastic band 74. Manual disassembly involves moving the first rod section 68 against the pull of the elastic band 74 in a manner sufficient to clear the sleeve 72, with the rod sections 68, 70 folded into a side-by-side arrangement with the elastic strand 74 under tension. It should be noted that while a two-section rod is illustrated in FIG. 6 for clarity, any number of rod sections may be used with the same general structure. Accordingly, the traverse rod 66 may be folded into sections and stowed in a folded condition shorter than its operational length, along with the smaller configuration of the sheet. Therefore, the combined traverse rods and sheet may be stowed away easily for vehicular transport.

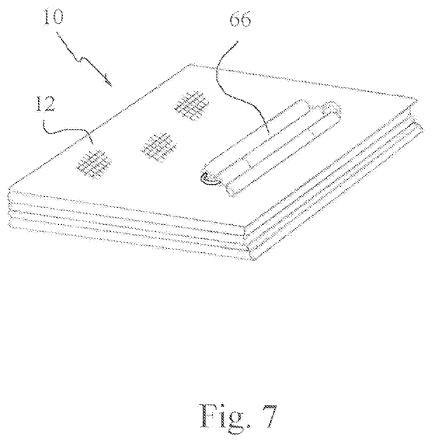

In use, the present decoy control apparatus 10 is transported to a hunting site and unfolded from its stowed condition, as seen in FIG. 7. With reference to FIGS. 1 and 2, a decoy spread DS is determined by the user and decoys D attached to the sheet 12 using the tethering means 18. As seen in FIG. 3, the first link 22 is opened at its latch 26 and, with reference to FIG. 2, directed through the opening 44 in the second link 28. A decoy D is then attached to the first link 22 by directing the first link 22 through the decoy eyelet DE and is then latched shut. It should be noted that the order of linking the first link 22 to the second link 28 and a decoy D can be done in any order as a matter of choice.

Once the decoys D are set in their predetermined pattern as seen in FIG. 1, the sheet may be cast upon the open waters for attachment of the ballast weight. It should be noted that the ballast weight may be attached before casting the sheet onto the open waters. Once again, the order of steps is the user's choice as a matter of ease of use based on the conditions at hand.

The traverse rod or traverse rods 66, depending upon user choice, may be unfolded as seen in FIG. 6 and set in a linear condition by directing the first rod section 68 into the sleeve 72 on the second rod section 70, as seen in FIG. 6. The elastic strands 74 will draw the rod sections 68, 70 together, the first rod section will fit snug in the sleeve 72. This is repeated, depending on the size of the rod and then the rod 66 is ready for receipt in the rod sleeve 62. The rod 66 is then inserted into the rod sleeve such that the rod is accessible through the access opening 62 as seen in FIG. 1. The apparatus is then ready for deployment or ballast attachment depending upon user choice.

With the ballast weight ready for attachment, i.e., the ballast weight is attached to a line L and a carabiner C or other clip member as desired, the carabiner C is engaged with the traverse rod 66. The ballast weight BW is then submerged and allowed to seek a resting spot on the floor F of the marine environment. With reference to FIG. 2, the result is that the buoyant decoys D float on the surface S of the marine environment while the ballast weight BW rests on the floor of the marine environment. The mesh sheet 12 with the anchor arrangements 46 defining the decoy pattern on the surface above is suspended in a submerged condition by action of the tension between the upwardly buoyed ducks and the downwardly biased ballast weight.

Multiple apparatus, according to the present invention, may be deployed strategically to define a landing zone for ducks.

Once the hunting has concluded, the various deployed decoy control apparatus are gathered and the decoys removed therefrom by unlatching the first link 22 and disengaging the first link 22 from the decoy eyelet DE. Any carabiner clips C are unfastened from their respective traverse rods 66 are then stowed in a manner of the user's choosing. The mesh sheet 12 may then be folded into sections, the rods 66 broken down into sections and the entire apparatus 10 may be compactly stowed in a hunter's vehicle for transport away from the hunting site.

By the foregoing the present invention provides a decoy control apparatus for organizing and displaying a predetermined spread of buoyant decoys in a free-surface marine environment that is effective in presenting a realistic decoy spread that facilitates defining a landing zone that will remain stable. Further, the decoy control apparatus may be easily folded and stowed for transport to and from the hunting site.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

We claim:

1. A decoy control apparatus for organizing and displaying a spread of buoyant decoys in a free-surface marine environment, the decoy control apparatus comprising:
a pliant, water permeable sheet for subsurface deployment, the sheet having two side edges and two end edges, wherein the sheet is deployable with a plurality of buoyant decoys attached thereto for surface display of the plurality of buoyant decoys grouped in a predetermined spread;
tethering means mounted to the sheet for removable, individual attachment of a plurality of buoyant decoys to the tethering means, the tethering means including a plurality of anchor arrangements, with each anchor arrangement including a first link formed from a rigid material, a second link formed from a flexible material, and a mounting arrangement for mounting the second link to the sheet, wherein the first link is directly and movably attached to the second link, thereby restricting movement of the first link relative to the second link, and wherein the first link is removably attachable to a buoyant decoy; and
a ballast attachment arrangement fixed to at least one end edge of the sheet for attachment of at least one ballast weight thereto to downwardly bias the sheet against the upward bias of the buoyant decoys, thereby stabilizing the sheet in a subsurface disposition intermediate the surface-borne buoyant decoys and the at least one ballast weight, thereby displaying the predetermined spread of buoyant decoys on the free-surface marine environment.

2. A decoy control apparatus according to claim 1 wherein the pliant, water permeable sheet includes a portion formed from mesh material wherein openings in the mesh material can pass water therethrough, thereby facilitating submersability of the decoy control apparatus.

3. A decoy control apparatus according to claim 2 wherein the mesh material is formed from a polymer material.

4. A decoy control apparatus according to claim 1 wherein each anchor arrangement includes a first link formed as a manually openable clip for selective operative engagement with the second link and a buoyant decoy.

5. A decoy control apparatus according to claim 1 wherein each anchor arrangement includes a second link formed as an elongate member folded to define a loop at a distal end thereof, with the loop being configured for selective operative engagement with the first link and wherein a proximal end of the second link is joined to the mounting arrangement.

6. A decoy control apparatus according to claim 5 and further comprising a clamping element fitted to the second link adjacent the distal end of the folded elongate member to limit an open area defined by the clamping element and the elongate member for passage of the first link therethrough, thereby limiting movement of the first link relative to the second link.

7. A decoy control apparatus according to claim 1 wherein each anchor arrangement includes a backing member attached to the sheet, and a cover member attached to the backing member, thereby defining a space intermediate the cover member and the backing member, the cover member having an access aperture formed therein for passage of a proximal end of the second link therethrough, and a retainer element attached to the cover member on a side of the cover member facing the backing member, for retention of the proximal end of the second link in the space intermediate the cover member and the backing member.

8. A decoy control apparatus according to claim 7 wherein the retainer element is a washer-like structure having a central aperture and the second link includes two legs, with each leg having a flared end element, wherein both legs of the second link can pass simultaneously though the central aperture, and wherein both flared end elements cannot pass simultaneously though the central aperture, thereby retaining the second link with both flared end elements disposed in the space intermediate the cover member and the backing member.

9. A decoy control apparatus according to claim 1 wherein the second link is formed from a bendable, polymer coated metal wire.

10. A decoy control apparatus according to claim 1 wherein the anchor arrangements are attached to the sheet in a predetermined pattern to thereby define a decoy spread.

11. A decoy control apparatus according to claim 1 wherein the ballast mounting arrangement includes a rod operatively associated with the sheet and configured for attachment of a ballast weight thereto for biasing the sheet into a stationary, submersed disposition during use.

12. A decoy control apparatus according to claim 11 wherein the ballast attachment arrangement includes at least one rod retaining sleeve attached to at least one end of the sheet.

13. A decoy control apparatus according to claim 12 wherein the rod retaining sleeve is formed as a planar element having an opening formed therein, the planar element being pliant and folded along a long axis thereof to define two planar sides, with each planar side being attached to opposing surfaces of the sheet thereby defining a cavity therebetween for rod receipt.

14. A decoy control apparatus according to claim 13 wherein the opening in the planar element exposes a section of the rod in the cavity for selective engagement by the ballast weight.

15. A decoy control apparatus according to claim 13 wherein the rod is formed in sections and is configured for partial disassembly, such that the rod can be folded for stowage with a folded sheet.

16. A decoy control apparatus for organizing and displaying a spread of buoyant decoys in a free-surface marine environment, the decoy control apparatus comprising:
a pliant, water permeable sheet for subsurface deployment, the sheet having two side edges and two end edges, wherein the sheet is deployable with a plurality of buoyant decoys attached thereto for surface display of the plurality of buoyant decoys grouped in a predetermined spread;
tethering means mounted to the sheet for removable, individual attachment of a plurality of buoyant decoys to the tethering means, the tethering means including a plurality of anchor arrangements, with each anchor arrangement including a first link, a second link and a mounting arrangement for mounting the second link to the sheet, wherein the first link is directly and movably attached to the second link, thereby restricting movement of the first link relative to the second link, and wherein the first link is removably attachable to a buoyant decoy; and
a ballast attachment arrangement including a rod operatively associated with the sheet and a rod retaining sleeve fixed to at least one end edge of the sheet for rod receipt, the sleeve being configured for rod access to allow attachment of at least one ballast weight thereto to downwardly bias the sheet against the upward bias of the buoyant decoys, thereby stabilizing the sheet in a subsurface disposition intermediate the surface-borne buoyant decoys and the at least one ballast weight, thereby displaying the predetermined spread of buoyant decoys on the free-surface marine environment.

17. A decoy control apparatus according to claim 16 wherein the rod retaining sleeve is formed as a planar element having an opening formed therein, the planar element being pliant and folded along a long axis thereof to define two planar sides, with each planar side being attached to opposing surfaces of the sheet thereby defining a cavity therebetween for rod receipt.

18. A decoy control apparatus according to claim 17 wherein the opening in the planar element exposes a section of the rod in the cavity for selective engagement by the ballast weight.

19. A decoy control apparatus according to claim 1 wherein the pliant, water permeable sheet includes a portion formed from mesh material wherein openings in the mesh material can pass water therethrough, thereby facilitating submersability of the decoy control apparatus.

20. A decoy control apparatus for organizing and displaying a spread of buoyant decoys in a free-surface marine environment, the decoy control apparatus comprising:
a pliant, water permeable sheet for subsurface deployment, the sheet having two side edges and two end edges, wherein the sheet is deployable with a plurality of buoyant decoys attached thereto for surface display of the plurality of buoyant decoys grouped in a predetermined spread;
tethering means mounted to the sheet for removable, individual attachment of a plurality of buoyant decoys to the tethering means, the tethering means including a plurality of anchor arrangements, with each anchor arrangement including a first link formed from a rigid material, a second link formed from a flexible material, and a mounting arrangement for mounting the second link to the sheet, wherein the first link is directly and movably attached to the second link, thereby restricting movement of the first link relative to the second link, and wherein the first link is removably attachable to a buoyant decoy; and
a ballast attachment arrangement including a rod operatively associated with the sheet and a rod retaining sleeve fixed to each end edge of the sheet for rod receipt, the sleeve including an opening for rod access to allow attachment of at least one ballast weight thereto to downwardly bias the sheet against the upward bias of the buoyant decoys, thereby stabilizing the sheet in a subsurface disposition intermediate the surface-borne buoyant decoys and the at least one ballast weight, thereby displaying the predetermined spread of buoyant decoys on the free-surface marine environment.
